(19) United States
(12) Patent Application Publication
(10) Pub. No.: US 2001/0041724 A1
(43) Pub. Date: Nov. 15, 2001

(54) METHOD FOR THE CONTROL OF FLEA BEETLES IN CANOLA

(76) Inventor: CARLA JEAN KLITTICH, ZIONSVILLE, IN (US)

Correspondence Address: MARY KATHERINE BAUMEISTER, BURNS, DOANE, SWECKER & MATHIS, L.L.P., P.O. BOX 1404, ALEXANDRIA, VA, 22313-1404, US

(21) Appl. No.: 09/365,240

(22) Filed: Jul. 30, 1999

Related U.S. Application Data
(60) Provisional application No. 60/095,467, filed on Aug. 4, 1998.

(51) Int. Cl. A01N 43/40

(52) U.S. Cl. 514/357

(57) ABSTRACT

A method of protecting a plant susceptible to attack by a Phyllotreta spp. insect from said attack which comprises applying to the seed from which the plant grows an effective amount of a chloronicotinyl insecticide or a salt thereof, which insecticide is other than imidacloprid and thiamethoxam; preferably the insecticide is acetamiprid.

This application claims the priority of copending U.S. Provisional Patent Application No. 60/095,467, filed Aug. 4, 1998, incorporated by reference herein in its entirety and relied upon.

The present invention relates to a new method for the control of flea beetles in plants.

At the present time, there exists a need to protect plants from infestation and damage by flea beetles. This problem exists particularly in portions of the North American continent where canola is raised for the value of its oil. At present, there is no one-stage chemical treatment effective to protect canola from the damage that is done by flea beetles. In fact, a generally accepted method comprises treating canola seed with lindane (a mixture of 1,2,3,4,5,6-hexachlorocyclohexanes), combining with granular terbufos (S-tert-butylthiomethyl O,O-diethyl phosphorodithioate) and then planting the seed/pesticide composition. It is generally known that lindane and other chlorinated hydrocarbon insecticides (as well as organophosphates) are being removed from agrochemical markets on a worldwide basis due their generally unacceptable persistency in the soil or acute toxicity to mammals. Thus, there exists a need for an improved treatment of canola from flea beetle attack.

An object of the present invention is to provide a new insecticidal treatment of canola seed.

Another object of the present invention is to provide a one-stage or one-step treatment of canola for protection from flea beetle.

Another object of the present invention is to provide a treatment of canola seed that is more environmentally acceptable than the state of the art.

Another object of the invention is to provide a treatment of canola seed that is superior to those in the state of the art.

These objects are met in whole or in part by the present invention.

The present invention provides a method of protecting a plant susceptible to attack by a Phyllotreta spp. insect from said attack which comprises applying to the seed from which the plant grows an effective amount of a chloronicotinyl insecticide or a salt thereof, which insecticide is other than imidacloprid and thiamethoxam.

Preferably the insecticide is (E)-N¹-[(6-chloro-3-pyridyl)methyl]-N²-cyano-N¹-methylacetamidine (acetamiprid or NI-25). The preparation and general uses of acetamiprid are described in U.S. Pat. No. 5,304,566 and in The Pesticide Manual, 10th edition, ed. C. Tomlin, British Crop Protection Council, 1994, p. 730.

Generally the Phyllotreta spp. is Phyllotreta cruciferae, which may also be known as turnip fly, crucifer flea beetle, or cabbage flea beetle. Generally the plant is a Brassica spp. plant. Preferably the Brassica plant is Brassica napus (also known as rape or rapeseed), Brassica rapa (also known as canola), or Brassica juncea (mustard).

Thus, in one preferred aspect of the invention, there is provided a method for protecting a plant in need of protection against Phyllotreta spp. insects, said method comprising applying to the seed from which the plant grows an amount of acetamiprid sufficient to protect the plant against Phyllotreta spp. insects.

In an even more preferred aspect of the invention, there is provided a method for protecting a Brassica spp. plant in need of protection against Phyllotreta spp. insects, said method comprising applying to the seed from which the plant grows an amount of acetamiprid sufficient to protect the plant against Phyllotreta spp. insects.

The method preferably comprises protecting the plant from the time of emergence from the seed from which it grows to flowering of the plant. This is generally the period during which the plant is susceptible to attack by Phyllotreta. Preferably, the plant is protected during the growth stage of from the expansion of the plant cotyledon to the sixth true leaf. Preferably the plant cotyledon has expanded.

Generally, a single treatment of the seed in accordance with the invention is sufficient to protect the plant for the desired period.

In general, the insecticide is applied to the seed in an amount of active ingredient of from 0.1 to 20 grams per kg of seed (g/kg), preferably from 1 to 10 g/kg and most preferably from 2.5 to 7.5 g/kg.

The seed treatment step is effected by conventional means of seed treatment known to those skilled in the art of seed treatment.

The present invention also provides a method of treating seed to protect the plant from which it grows, the said method comprising applying to the seed an insecticidally effective amount of a chloronicotinyl insecticide or a composition comprising the insecticide, which insecticide is other than imidacloprid or thiamethoxam, and is preferably acetamiprid.

The invention also provides the seed so treated by said method of treatment.

The following non-limiting example illustrates but does not limit the invention.

### EXAMPLE 1

Acetamiprid is applied to canola seed at rates of 7.5, 10, and 12.5 grams of active ingredient per kg of seed. Imidacloprid is applied to canola seed at rate of 15 g/kg of seed. The seed is planted and allowed to grow. At 4, 7, 10 and 14 days post-emergence of the plant, damage is assessed for the plants by looking for shot-hole damage. All treatments with acetamiprid provide substantially more control than imidacloprid and are generally equivalent to the two stage lindane+terbufos treatment. At the end of the growing season, there is a general yield increase in plants which are grown from seed that has been treated by acetamiprid.

While the invention has been described in terms of various preferred embodiments, the person skilled in the art will appreciate that various modifications, substitutions, omissions and changes can be made without departing from the spirit thereof. Accordingly, it is intended that the scope of the present invention be limited by the scope of the following claims, including equivalents thereof.

What is claimed is:

1. A method for protecting a plant in need of protection against Phyllotreta spp. insects, said method comprising applying to the seed from which the plant grows an amount of acetamiprid sufficient to protect the plant against Phyllotreta spp. insects.

2. A method for protecting a Brassica spp. plant in need of protection against Phyllotreta spp. insects, said method comprising applying to the seed from which the plant grows an amount of acetamiprid sufficient to protect the plant against Phyllotreta spp. insects.

3. A method according to claim 2, wherein the plant is Brassica napus, Brassica rapa or Brassica juncea.

4. A method according to claim 3, wherein the plant is Brassica rapa.

5. A method according to claim 2, wherein the insects are Phyllotreta cruciferae.

6. A method according to claim 3, wherein the insects are Phyllotreta cruciferae.

7. A method according to claim 4, wherein the insects are Phyllotreta cruciferae.

8. A method according to claim 1, wherein the plant is protected for the period extending from the time of its emergence from the seed from which it grows to the flowering of the plant.

9. A method according to claim 2, wherein the plant is protected for the period extending from the time of its emergence from the seed from which it grows to the flowering of the plant.

10. A method according to claim 3, wherein the plant is protected for the period extending from the time of its emergence from the seed from which it grows to the flowering of the plant.

11. A method according to claim 4, wherein the plant is protected for the period extending from the time of its emergence from the seed from which it grows to the flowering of the plant.

12. A method according to claim 5, wherein the plant is protected for the period extending from the time of its emergence from the seed from which it grows to the flowering of the plant.

13. A method according to claim 6, wherein the plant is protected for the period extending from the time of its emergence from the seed from which it grows to the flowering of the plant.

14. A method according to claim 7, wherein the plant is protected for the period extending from the time of its emergence from the seed from which it grows to the flowering of the plant.

15. A method according to claim 1, wherein the plant is protected for the period of growth from the expansion of the plant cotyledon to the sixth true leaf.

16. A method according to claim 2, wherein the plant is protected for the period of growth from the expansion of the plant cotyledon to the sixth true leaf.

17. A method according to claim 3, wherein the plant is protected for the period of growth from the expansion of the plant cotyledon to the sixth true leaf.

18. A method according to claim 4, wherein the plant is protected for the period of growth from the expansion of the plant cotyledon to the sixth true leaf.

19. A method according to claim 5, wherein the plant is protected for the period of growth from the expansion of the plant cotyledon to the sixth true leaf.

20. A method according to claim 6, wherein the plant is protected for the period of growth from the expansion of the plant cotyledon to the sixth true leaf.

21. A method according to claim 7, wherein the plant is protected for the period of growth from the expansion of the plant cotyledon to the sixth true leaf.

22. A method according to claim 1, wherein acetamiprid is applied in an amount of from 0.1 g to 20 g per kg of seed.

23. A method according to claim 2, wherein acetamiprid is applied in an amount of from 0.1 g to 20 g per kg of seed.

24. A method according to claim 22, wherein acetamiprid is applied in an amount of from 1 g to 10 g per kg of seed.

25. A method according to claim 23, wherein acetamiprid is applied in an amount of from 1 g to 10 g per kg of seed.

26. A method according to claim 24, wherein acetamiprid is applied in an amount of from 2.5 g to 7.5 g per kg of seed.

27. A method according to claim 25, wherein acetamiprid is applied in an amount of from 2.5 g to 7.5 g per kg of seed.
